(19) United States
(12) Patent Application Publication
(10) Pub. No.: US 2014/0007855 A1
(43) Pub. Date: Jan. 9, 2014

(54) INTERNAL EGR AMOUNT CALCULATION DEVICE FOR INTERNAL COMBUSTION ENGINE

(71) Applicant: HONDA MOTOR CO., LTD., Tokyo (JP)

(72) Inventors: Yosuke KOSAKA, Wako-shi (JP); Koichiro SHINOZAKI, Wako-shi (JP)

(21) Appl. No.: 13/928,989

(22) Filed: Jun. 27, 2013

(30) Foreign Application Priority Data
Jul. 6, 2012 (JP) 2012-152089

(51) Int. Cl. F02D 41/02

(52) U.S. Cl. CPC F02D 41/02
USPC 123/568.21

(57) ABSTRACT

An internal EGR amount calculation device for an internal combustion engine, which is capable of properly and easily calculating an internal EGR amount, thereby making it possible to achieve improvement of calculation accuracy and reduction of computational load, even when the degree of fluctuation in an exhaust pressure during a valve overlap time period is large. The internal EGR amount calculation device of the engine includes an ECU. The ECU calculates a minimum exhaust pressure which is a minimum value of an exhaust pressure during the valve overlap time period, and calculates a blown back gas amount according to the minimum exhaust pressure. Further, the ECU calculates an average exhaust pressure and calculates a remaining gas amount according to the average exhaust pressure. Then, the ECU calculates the internal EGR amount based on the remaining gas amount and the blown back gas amount.

### BACKGROUND OF THE INVENTION

1. Field of the Invention

The present invention relates to an internal EGR amount calculation device for an internal combustion engine, for calculating an internal EGR amount of the engine.

2. Description of the Related Art

Conventionally, an internal EGR amount calculation device for an internal combustion engine is known as disclosed in Japanese Laid-Open Patent Publication (Kokai) No. 2004-251182 is known. In this internal EGR amount calculation device, an internal EGR amount is calculated by adding the amount of blown back gases to the amount of residual burned gases. The amount of residual burned gases represents the amount of burned gases remaining in a cylinder, and is calculated, specifically, using an in-cylinder capacity and the like by the equation of state of gas.

Further, the amount of blown back gases represents the amount of burned gases blown back into the cylinder after the burned gases flows from an exhaust passage into an intake passage due to a pressure difference between the intake passage and the exhaust passage, during a valve overlap time period. The amount of blown back gases is calculated using a calculation equation to which is applied the nozzle equation by regarding a path through which burned gases flows as a nozzle. This calculation equation for calculating the blown back gas amount uses a pressure ratio between an intake pressure, which is a pressure within the intake passage, and an exhaust pressure, which is a pressure within the exhaust passage. Further, this calculation equation includes a time-integral value Σ(μA) of an effective opening area. The time-integral value Σ(μA) of the effective opening area is calculated, specifically by calculating a crank angle-integral value fl(OL) by integrating the effective opening area with respect to crank angle, and dividing the crank angle-integral value fl(OL) by a rotational speed NE of the engine.

In the engine which changes the valve overlap time period, the exhaust pressure generally exhibits a behavior that it increases after temporarily decreasing during the valve overlap time period. In this case, when the valve overlap time period is long, the degree of fluctuation in the exhaust pressure becomes larger than when the valve overlap time period is short, due to an increase of the amount of gases flowing between the exhaust passage side and the intake passage side. In addition, the engine has a characteristic that during the high-load operation of the engine, the degree of fluctuation in the exhaust pressure during the valve overlap time period becomes larger than during the low-load operation thereof, due to the pulsation of exhaust gases.

However, in the case of the internal EGR amount calculation device disclosed in Japanese Laid-Open Patent Publication (Kokai) No. 2004-251182, the above-mentioned characteristic is not taken into account, so that when the degree of fluctuation in the exhaust pressure increases, an error in the calculation of the blown back gas amount increases, causing lowered calculation accuracy of the internal EGR amount. Further, when the operating conditions of the engine are controlled using the internal EGR amount calculated with such a low calculation accuracy, the combustion state of the engine is deteriorated to cause knocking. Furthermore, the calculation equation for calculating the blown back gas amount includes the time-integral value Σ(μA) of the effective opening area, and hence to calculate the time-integral value Σ(μA) of the effective opening area, it is required to integrate the effective opening area with respect to the crank angle, which increases computational load.

### SUMMARY OF THE INVENTION

It is an object of the present invention to provide an internal EGR amount calculation device for an internal combustion engine, which, even when the degree of fluctuation in an exhaust pressure during a valve overlap time period is large, is capable of properly and easily calculating an internal EGR amount, thereby making it possible to achieve improvement of calculation accuracy and reduction of computational load.

To attain the above object, the present invention provides an internal EGR amount calculation device for an internal combustion engine in which a valve overlap time period of an intake valve and an exhaust valve of a cylinder is changed by changing valve timing of at least one of the intake valve and the exhaust valve and an internal EGR amount is changed according to the change in the valve overlap time period, comprising first exhaust pressure parameter-obtaining means for obtaining a first exhaust pressure parameter indicative of a pressure within an exhaust passage during the valve overlap time period, second exhaust pressure parameter-obtaining means for obtaining a second exhaust pressure parameter indicative of the pressure within the exhaust passage during a predetermined time period including at least a time period other than the valve overlap time period, blown back gas amount-calculating means for calculating a blown back gas amount, which is an amount of burned gases which temporarily flow out of the cylinder into at least one of an intake system and an exhaust system, and then flow back into the cylinder again, according to the first exhaust pressure parameter, remaining gas amount-calculating means for calculating a remaining gas amount, which is an amount of burned gases remaining in the cylinder, according to the second exhaust pressure parameter, and internal EGR amount-calculating means for calculating the internal EGR amount based on the remaining gas amount and the blown back gas amount.

With the configuration of this internal EGR amount calculation device, the blown back gas amount, which is an amount of burned gases which temporarily flow out of the cylinder into at least one of an intake system and an exhaust system, and then flow back into the cylinder again, is calculated according to the first exhaust pressure parameter, and the remaining gas amount, which is am amount of burned gases remaining in the cylinder, is calculated according to the second exhaust pressure parameter. Further, the internal EGR amount is calculated based on the remaining gas amount and the blown back gas amount. In this case, the first exhaust pressure parameter indicates the pressure within the exhaust passage during the valve overlap time period, and hence by calculating the blown back gas amount according to the first exhaust pressure parameter thus calculated, it is possible to accurately calculate the blown back gas amount, while causing a state of the change in the exhaust pressure to be reflected on the blown back gas amount, even under a condition that the degree of fluctuation in the exhaust pressure during the valve overlap time period is large. This makes it possible to properly calculate the internal EGR amount, and thereby makes it possible to improve the calculation accuracy of the internal EGR amount (Note that throughout the specification, the term “obtain” used in the phrases “obtaining the first exhaust pressure parameter”, “obtaining the second exhaust pressure parameter”, and so forth is intended to include the meaning of directly detecting the parameters using sensors or the like, and estimating these parameters based on other parameters).

Preferably, the first exhaust pressure parameter-obtaining means obtains a minimum exhaust pressure, which is a minimum value of the pressure within the exhaust passage during the valve overlap time period, as the first exhaust pressure parameter.

The present assignee has confirmed by experiment that in general, in an internal combustion engine having a valve overlap time period, when a blown back gas amount is calculated, if the valve overlap time period is long or if the operating load of the engine is high, the calculation accuracy of the blown back gas amount is improved by using the minimum value of a pressure within an exhaust passage during the valve overlap time period (see FIGS. 9 and 10, referred to hereinafter). Therefore, with the configuration of the preferred embodiment, the minimum exhaust pressure, which is the minimum value of the pressure within the exhaust passage during the valve overlap time period, is obtained as the first exhaust pressure parameter, and the blown back gas amount is calculated according to the obtained minimum exhaust pressure. This makes it possible to further improve the calculation accuracy of the blown back gas amount. Further, the blown back gas amount is calculated according to the minimum exhaust pressure, and hence the blown back gas amount can be calculated more easily and computational load in calculating the blown back gas amount can be made smaller, than when the blown back gas amount is calculated by a method disclosed in Japanese Laid-Open Patent Publication (Kokai) No. 2004-251182, which executes integral calculation of the effective opening area. Furthermore, for the same reason, there is no possibility that the internal EGR amount is calculated as too large a value, whereby when the engine is controlled using the internal EGR amount thus calculated, it is possible to prevent the combustion state of the engine from being deteriorated to thereby prevent occurrence of knocking.

More preferably, the second exhaust pressure parameter-obtaining means includes average exhaust pressure-calculating means for calculating an average exhaust pressure, which is an average value of the pressure within the exhaust passage during the predetermined time period, as the second exhaust pressure parameter, and the first exhaust pressure parameter-obtaining means includes amplitude calculating means for calculating an amplitude for calculating the minimum exhaust pressure, according to a value indicative of an operating condition of the engine, and minimum exhaust pressure-calculating means for calculating the minimum exhaust pressure, based on the amplitude and the average exhaust pressure.

With the configuration of the preferred embodiment, the amplitude for calculating the minimum exhaust pressure is calculated according to the value indicative of the operating condition of the engine, and the minimum exhaust pressure is calculated based on the amplitude and the average exhaust pressure. Therefore, by using a map search method or a calculation equation as a method of calculating the amplitude, it is possible to calculate the blown back gas amount more easily, and further reduce the computational load in calculating the blown back gas amount, than when the blown back gas amount is calculated by the method disclosed in Japanese Laid-Open Patent Publication (Kokai) No. 2004-251182, which executes integral calculation of the effective opening area.

The above and other objects, features, and advantages of the present invention will become more apparent from the following detailed description taken in conjunction with the accompanying drawings.

### BRIEF DESCRIPTION OF THE DRAWINGS

FIG. 1 is a schematic diagram of an internal EGR amount calculation device according to an embodiment of the present invention and an internal combustion engine to which the internal EGR amount calculation device is applied;

FIG. 2 is a diagram of valve lift curves showing changes in valve timings of an intake valve and an exhaust valve caused by a variable intake cam phase mechanism and a variable exhaust cam phase mechanism;

FIG. 3 is a functional block diagram of the internal EGR amount calculation device;

FIG. 4 is a block diagram of a blown back gas amount-calculating section;

FIG. 5 is a diagram showing an example of a map for use in calculating a function value;

FIG. 6A is a diagram showing valve lift curves obtained when CAIN=CAEX=0 hold;

FIG. 6B is a diagram showing an example of a result of measurement of an exhaust flow rate obtained when CAIN=CAEX=0 holds;

FIG. 6C is a diagram showing an example of a result of measurement of an exhaust pressure obtained when CAIN=CAEX=0 holds;

FIG. 7A is a diagram showing valve lift curves obtained when CAIN=CAEX=CAREF holds and the engine is in low-load operation;

FIG. 7B is a diagram showing an example of a result of measurement of the exhaust pressure obtained when CAIN=CAEX=CAREF holds and the engine is in low-load operation;

FIG. 8A is a diagram showing valve lift curves obtained when CAIN=CAEX=CAREF holds and the engine is in high-load operation;

FIG. 8B is a diagram showing an example of a result of measurement of the exhaust pressure obtained when CAIN=CAEX=CAREF holds and the engine is in high-load operation;

FIG. 9 is a diagram showing an example of a calculation error caused when a basic blown back gas amount is calculated using a minimum exhaust pressure; and

FIG. 10 is a diagram showing an example of a calculation error caused when the basic blown back gas amount is calculated using an average exhaust pressure.

### DETAILED DESCRIPTION OF PREFERRED EMBODIMENTS

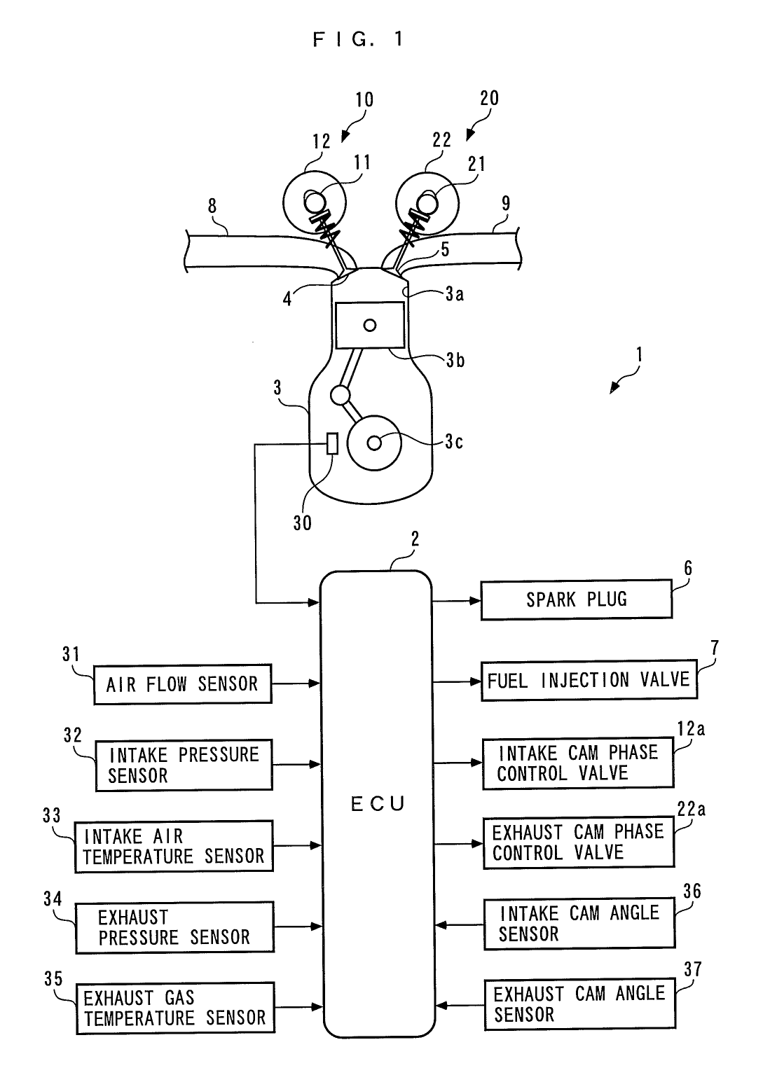

Hereafter, an internal EGR amount calculation device for an internal combustion engine according to an embodiment of the invention will be described with reference to drawings. As shown in FIG. 1, the internal EGR amount calculation device 1 includes an ECU 2. The ECU 2 calculates an internal EGR amount by a method, described hereinafter, and controls operating conditions of the internal combustion engine (hereafter referred to as the “engine”) 3.

The engine 3 is an in-line four-cylinder gasoline engine having four pairs of cylinders 3a and pistons 3b (only one pair of which is shown), and is installed on a vehicle, not shown. The engine 3 includes intake valves 4 (only one of which is shown) provided for the respective cylinders 3a, exhaust valves 5 (only one of which is shown) provided for the respective cylinders 3a, an intake valve-actuating mechanism 10 for actuating the intake valves 4 to open and close the same, an exhaust valve-actuating mechanism 20 for actuating the exhaust valves 5 to open and close the same, and so forth.

The intake valve-actuating mechanism 10 comprises an intake cam shaft 11 for actuating the intake valves 4, and a variable intake cam phase mechanism 12. The variable intake cam phase mechanism 12 steplessly (i.e. continuously) changes a phase CAIN of the intake camshaft 11 with respect to a crankshaft 3c (hereafter referred to as the “intake cam phase CAIN”) to an advanced side or a retarded side, to thereby change the valve timing of the intake valves 4. The variable intake cam phase mechanism 12 is disposed at an end of the intake cam shaft 11 toward an intake sprocket (not shown).

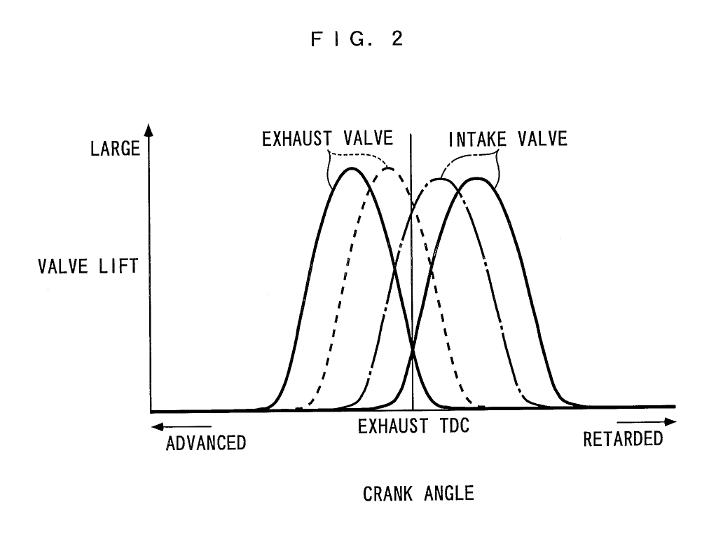

Although the variable intake cam phase mechanism 12 is configured, specifically, similarly to one proposed by the present assignee in Japanese Laid-Open Patent Publication (Kokai) No. 2007-100522, and hence detailed description thereof is omitted, the variable intake cam phase mechanism 12 includes an intake cam phase control valve 12a. In the case of the variable intake cam phase mechanism 12, the intake cam phase control valve 12a is controlled by a drive signal from the ECU 2, whereby the intake cam phase CAIN is continuously varied between a predetermined origin value CAIN_{—}0 and a predetermined most advanced value CAIN_ad. This steplessly changes the valve timing of the intake valves 4 between an origin timing indicated by a solid line in FIG. 2 and the most advanced timing indicated by a one-dot chain line in FIG. 2. Note that in FIG. 2, an exhaust dead center is represented by an “exhaust TDC”. This also applies to figures, referred to hereinafter.

In this case, the predetermined origin value CAIN_{—}0 is set to 0, and the predetermined most advanced value CAIN_ad is set to a predetermined positive value. Therefore, as the intake cam. phase CAIN is increased from 0, the valve timing of the intake valves 4 is changed to a more advanced timing than the origin timing, whereby a valve overlap time period of the intake valves 4 and the exhaust valves 5 becomes longer.

The exhaust valve-actuating mechanism 20 comprises an exhaust cam shaft 21 for actuating the exhaust valves 5, and a variable exhaust cam phase mechanism 22. The variable exhaust cam phase mechanism 22 steplessly (i.e. continuously) changes a phase CAEX of the exhaust cam shaft 21 with respect to the crankshaft 3c (hereafter referred to as the “exhaust cam phase CAEX”) to the advanced side or the retarded side, to thereby change the valve timing of the exhaust valves 5. The variable exhaust cam phase mechanism 22 is disposed at an end of the exhaust camshaft 21 toward an exhaust sprocket (not shown).

The variable exhaust cam phase mechanism 22 is configured similarly to the above-described variable intake cam phase mechanism 12, and includes an exhaust cam phase control valve 22a. In the case of the variable exhaust cam phase mechanism 22, the exhaust cam phase control valve 22a is controlled by a drive signal from the ECU 2, whereby the exhaust cam phase CAEX is continuously varied between a predetermined origin value CAEX_{—}0 and a predetermined most retarded value CAEX_rt. This steplessly changes the valve timing of the exhaust valves 5 between an origin timing indicated by a solid line in FIG. 2 and the most retarded timing indicated by a broken line in FIG. 2.

In this case, the predetermined origin value CAEX_{—}0 is set to 0, and the predetermined most retarded value CAEX_rt is set to a predetermined positive value. Therefore, as the exhaust cam phase CAEX is increased from 0, the valve timing of the exhaust valves 5 is changed to a more retarded timing than the origin timing, whereby the valve overlap time period becomes longer.

Note that when there is such a valve overlap time period, there occur, as described hereinafter, a phenomenon in which burned gases having temporarily flowed out of the cylinder 3a into an exhaust passage 9 (exhaust system) flow into the cylinder 3a again, or a phenomenon in which burned gases having flowed into an intake passage 8 (intake system) through the cylinder 3a flow into the cylinder 3a again. In the following description, burned gases which once flow out of the cylinder 3a into the exhaust passage 9 and thereafter finally flow back into the cylinder 3a before the termination of the valve overlap time period, as described above, will be referred to as “blown back gases”, and the amount of the blown back gases will be referred to as the “blown back gas amount”.

Further, the engine 3 is provided with spark plugs 6, fuel injection valves 7, and a crank angle sensor 30. The spark plugs 6 and the fuel injection valves 7 are provided for the respective cylinders 3a (only one of each of which is shown). The fuel injection valves 7 are mounted in an intake manifold such that fuel is injected into intake ports of the respective cylinders 3a. Both the spark plugs 6 and the fuel injection valves 7 are electrically connected to the ECU 2, and a fuel injection amount and fuel injection timing of fuel injected from each fuel injection valve 7, and an ignition timing in which a mixture is ignited by each spark plug 6 are controlled by the ECU 2. That is, fuel injection control and ignition timing control are executed.

The crank angle sensor 30 delivers a CRK signal and a TDC signal, which are both pulse signals, to the ECU 2 along with rotation of the crankshaft 3c. Each pulse of the CRK signal is generated whenever the crankshaft 3c rotates through a predetermined crank angle (e.g. 1°). The ECU 2 calculates a rotational speed NE of the engine 3 (hereafter referred to as “the engine speed NE”) based on the CRK signal. Further, the TDC signal indicates that the piston 3b in one of the cylinders 3a is in a predetermined crank angle position slightly before the TDC position of the intake stroke, and each pulse thereof is delivered whenever the crankshaft rotates through 180°, in the case of the four-cylinder engine 3 in the present embodiment.

On the other hand, an air flow sensor 31, an intake pressure sensor 32, an intake air temperature sensor 33, an exhaust pressure sensor 34, an exhaust gas temperature sensor 35, an intake cam angle sensor 36, and an exhaust cam angle sensor 37 are electrically connected to the ECU 2. The air flow sensor 31 detects the flow rate of fresh air flowing through the intake passage 8, and delivers a signal indicative of the detected flow rate of fresh air to the ECU 2. The ECU 2 calculates an intake air amount GAIR based on the detection signal from the air flow sensor 31.

The intake pressure sensor 32 detects a pressure Pin within the intake passage 8 (hereafter referred to as the “intake pressure Pin”), and delivers a signal indicative of the detected intake pressure Pin to the ECU 2. The intake pressure Pin is detected as an absolute pressure. Further, the intake air temperature sensor 33 detects a temperature Tin of air within the intake passage 8 (hereafter referred to as the “intake air temperature Tin”), and delivers a signal indicative of the detected intake air temperature Tin to the ECU 2. The intake air temperature Tin is detected as an absolute temperature.

On the other hand, the exhaust pressure sensor 34 detects a pressure Pex within the exhaust passage 9 (hereafter referred to as the “exhaust pressure Pex”), and delivers a signal indicative of the detected exhaust pressure Pex to the ECU 2. The exhaust pressure Pex is detected as an absolute pressure. Note that in the present embodiment, the exhaust pressure sensor 34 corresponds to first exhaust pressure parameter-obtaining means and second exhaust pressure parameter-obtaining means. Further, the exhaust gas temperature sensor 35 detects a temperature Tex of exhaust gases flowing through the exhaust passage 9 (hereafter referred to as the “exhaust temperature Tex”), and delivers a signal indicative of the detected exhaust temperature Tex to the ECU 2. The exhaust temperature Tex is detected as an absolute temperature. Further, the intake cam angle sensor 36 is disposed at an end of the intake cam shaft 11 on a side thereof remote from the variable intake cam phase mechanism 12, and delivers an intake cam signal, which is a pulse signal, to the ECU 2 along with rotation of the intake cam shaft 11 whenever the intake cam shaft 11 rotates through a predetermined cam angle (e.g. 1°). The ECU 2 calculates the intake cam phase CAIN based on the intake cam signal and the above-mentioned CRK signal.

Further, the exhaust cam angle sensor 37 is disposed at an end of the exhaust cam shaft 21 on a side thereof remote from the variable exhaust cam phase mechanism 22, and delivers an exhaust cam signal, which is a pulse signal, to the ECU 2 along with rotation of the exhaust cam shaft 21 whenever the exhaust cam shaft 21 rotates through a predetermined cam angle (e.g. 1°). The ECU 2 calculates the exhaust cam phase CAEX based on the exhaust cam signal and the above-mentioned CRK signal.

On the other hand, the ECU 2 is implemented by a microcomputer comprising a CPU, a RAM, a ROM, and an I/O interface (none of which are specifically shown). Further, the ECU 2 executes a process for calculating an internal EGR amount based on the detection signals from the aforementioned sensors 30 to 37, as described hereinafter, and controls the operations of the spark plugs 6, the fuel injection valves 7, the intake cam phase control valve 12a, and the exhaust cam phase control valve 22a.

Note that in the present embodiment, the ECU 2 corresponds to first exhaust pressure parameter-obtaining means, second exhaust pressure parameter-obtaining means, blown back gas amount-calculating means, remaining gas amount-calculating means, internal EGR amount-calculating means, average exhaust pressure-calculating means, amplitude calculating means, and minimum exhaust pressure-calculating means.

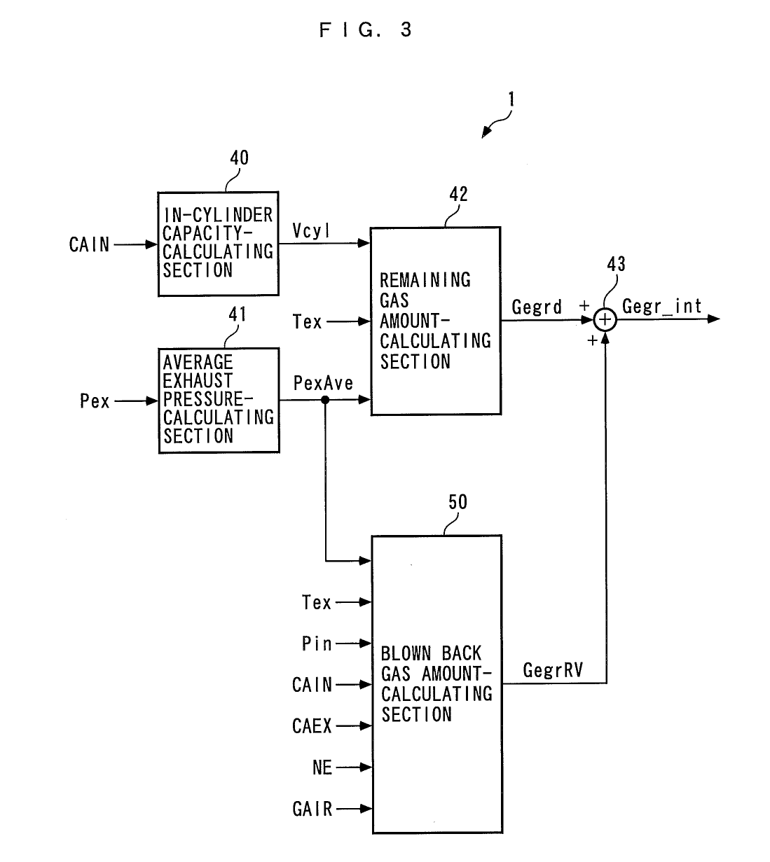

Next, the functional configuration of the internal EGR amount calculation device 1 according to the present embodiment will be described with reference to FIG. 3. As shown in FIG. 3, the internal EGR amount calculation device 1 comprises an in-cylinder capacity-calculating section 40, an average exhaust pressure-calculating section 41, a remaining gas amount-calculating section 42, an adder 43, and a blown back gas amount-calculating section 50, all of which are implemented by the ECU 2.

The in-cylinder capacity-calculating section 40 calculates an in-cylinder capacity Vcyl by searching a table, not shown, according to the intake cam phase CAIN. The in-cylinder capacity Vcyl represents the capacity of each cylinder 3a in the valve-opening timing of an associated one of the intake valves 4, and has a characteristic that it depends on the valve-opening timing of the intake valve 4. Therefore, in the present embodiment, the intake cam phase CAIN that decides the valve-opening timing of the intake valve 4 is used, and the in-cylinder capacity Vcyl is calculated by a method of searching a table according to the intake cam phase CAIN.

Further, the average exhaust pressure-calculating section 41 calculates an average exhaust pressure PexAve (second exhaust pressure parameter), as described hereafter. More specifically, the average exhaust pressure PexAve is calculated by sampling the exhaust pressure Pex in synchronism with generation of the TDC signal, and performing moving average processing of sampled values of the exhaust pressure Pex per one combustion cycle.

Furthermore, the remaining gas amount-calculating section 42 calculates a remaining gas amount Gegrd by the following equation (1):

$$Gegrd = \frac{PexAve \cdot Vcyl}{Re \cdot Tex} \qquad ( 1 )$$

This equation (1) corresponds to the equation of state of gas, wherein Re represents a gas constant. The remaining gas amount Gegrd corresponds to the amount of burned gases remaining in the cylinder 3a immediately before the intake valve 4 opens.

Further, the blown back gas amount-calculating section 50 calculates a blown back gas amount GegrRV using various parameters, such as the average exhaust pressure PexAve and the exhaust temperature Tex by a method, described hereinafter.

Then, the adder 43 calculates an internal EGR amount Gegr_int by the following equation (2):

Gegr_int=Gegrd+GegrRV (2)

As expressed by the above-mentioned equation (2), the internal EGR amount calculation device 1 calculates the internal EGR amount Gegr_int as the sum of the remaining gas amount Gegrd and the blown back gas amount GegrRV.

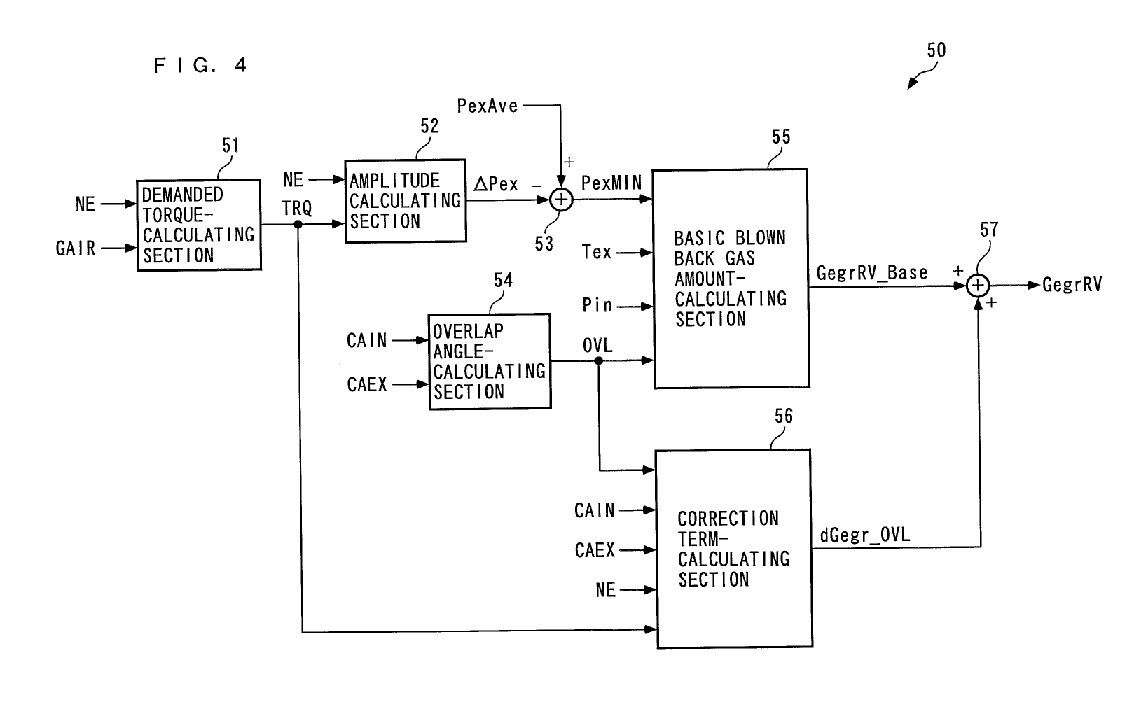

Next, the blown back gas amount-calculating section 50 will be described with reference to FIG. 4. As shown in FIG. 4, the blown back gas amount-calculating section 50 comprises a demanded torque-calculating section 51, an amplitude calculating section 52, a subtractor 53, an overlap angle-calculating section 54, a basic blown back gas amount-calculating section 55, a correction term-calculating section 56, and an adder 57.

First, the demanded torque-calculating section 51 calculates a demanded torque TRQ by searching a map, not shown, according to the engine speed NE and the intake air amount GAIR.

Next, the amplitude calculating section 52 calculates an amplitude ΔPex by searching a map, not shown, according to the demanded torque TRQ and the engine speed NE. Note that in the present embodiment, the engine speed NE and the intake air amount GAIR correspond to values representing operating conditions of the engine 3.

Then, the subtractor 53 calculates a minimum exhaust pressure PexMIN (first exhaust pressure parameter) by the following equation (3). The minimum exhaust pressure PexMIN corresponds to a value obtained by estimating the minimum value of the exhaust pressure Pex during the valve overlap time period.

PexMIN=PexAve−ΔPex (3)

On the other hand, the overlap angle-calculating section 54 calculates an overlap angle OVL by the following equation (4):

OVL=CAIN+CAEX (4)

Further, the basic blown back gas amount-calculating section 55 calculates a basic blown back gas amount GegrRV_Base using the following equations (5) to (7). The basic blown back gas amount GegrRV_Base corresponds to a blown back gas amount obtained when CAIN=CAEX holds.

$$\begin{matrix}GegrRv\_Base = CdA \cdot \frac{PexMIN}{\sqrt{Re \cdot Tex}} \cdot Ψ & ( 5 ) \\ • WHEN \frac{Pin}{PexMIN} > {( \frac{2}{K + 1} )}^{\frac{K}{K - 1}} \\ Ψ = \sqrt{\frac{2 K}{K - 1} \{ {( \frac{Pin}{PexMIN} )}^{\frac{2}{K}} - {( \frac{Pin}{PexMIN} )}^{\frac{K + 1}{K}} \}} & ( 6 ) \\ • WHEN \frac{Pin}{PexMIN} ≦ {( \frac{2}{K + 1} )}^{\frac{K}{K - 1}} \\ Ψ = \sqrt{{K ( \frac{2}{K + 1} )}^{\frac{K + 1}{K - 1}}} & ( 7 )\end{matrix}$$

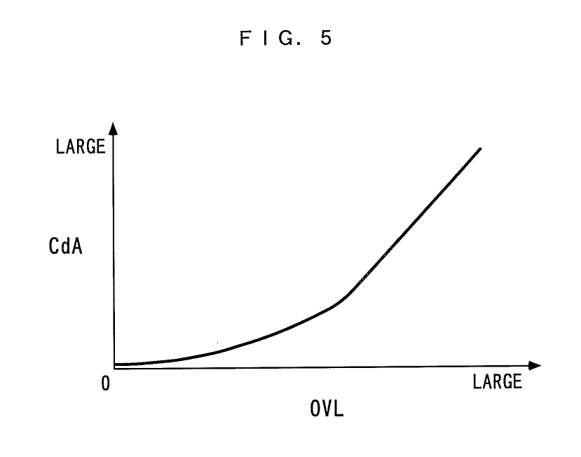

In the above-mentioned equation (5), CdA represents a function value corresponding to the product of an effective opening area and a flow rate coefficient. The function value CdA is specifically calculated by searching a map shown in FIG. 5 according to the overlap angle OVL. Further, in the equation (5), Ψ represents a flow rate function calculated by the equations (6) and (7). Further, in the equations (6) and (7), κ represents a specific heat ratio. As expressed by the above-described equations (5) to (7), in the present embodiment, the basic blown back gas amount GegrRV_Base is calculated using the minimum exhaust pressure PexMIN, and the reason for this will be described hereinafter.

Note that the above-described equations (5) to (7) are derived using a nozzle equation by regarding blown back gases (i.e. burned gases) as an adiabatic flow of compressible fluid and at the same time regarding a path through which blown back gases flow as a nozzle. A method of deriving the equations (5) to (7) is the same as one disclosed e.g. in Japanese Laid-Open Patent Publication (Kokai) No. 2011-140895 by the present assignee, and description thereof is omitted.

The correction term-calculating section 56 calculates a correction term dGegr_OVL, as described hereafter. First, the correction term-calculating section 56 calculates a correction coefficient KGegr by searching a map, not shown, according to the overlap angle OVL and the demanded torque TRQ. Further, the correction term-calculating section 56 calculates an overlap center position OVL_Center based on the exhaust cam phase CAEX and the intake cam phase CAIN. The overlap center position OVL_Center corresponds to a crank angle position at a center between the start point and end point of the valve overlap time period. The correction term dGegr_OVL is calculated by multiplying the overlap center position OVL_Center by the correction coefficient KGegr.

Then, finally, the adder 50 calculates the blown back gas amount GegrRV by the following equation (8):

GegrRV=GegrRV_Base+dGegr_OVL (8)

As described above, the blown back gas amount GegrRV is calculated by correcting the basic blown back gas amount GegrRV_Base using the correction term dGegr_OVL.

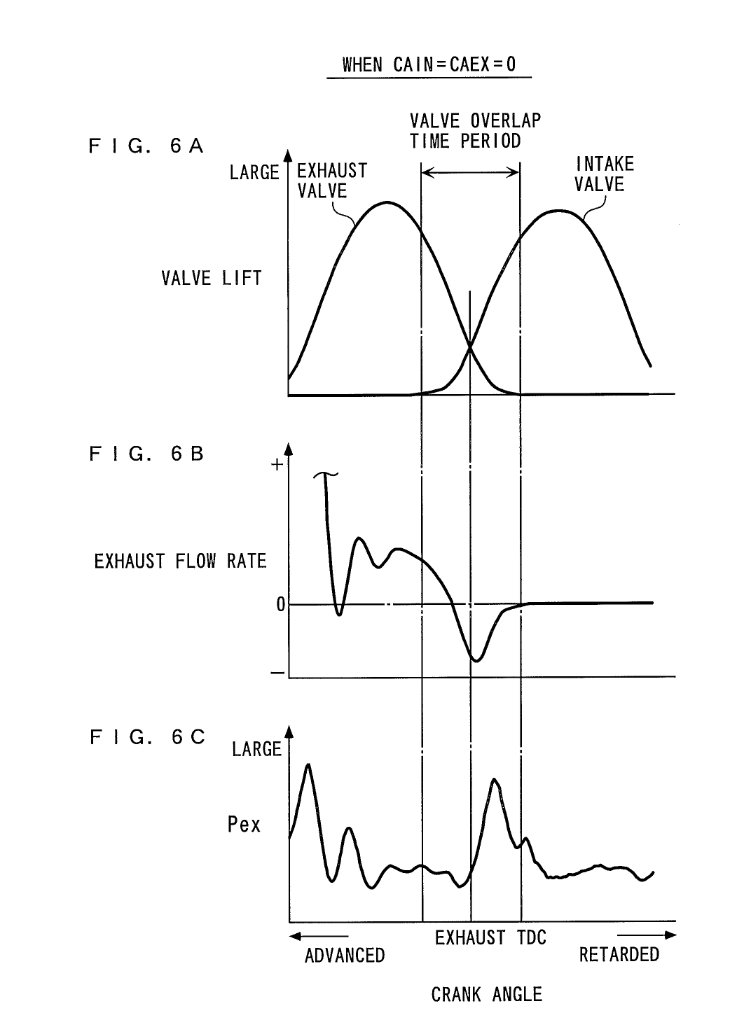

Next, the reason for and the viewpoint of calculating the basic blown back gas amount GegrRV_Base using the minimum exhaust pressure PexMIN, as described hereinabove, will be described with reference to FIGS. 6A to 6C to 10. First, as shown in FIG. 6A, when CAIN=CAEX=0 holds, the overlap center position OVL_Center becomes an exhaust top dead center. In this case, as shown in FIG. 6B, burned gases flow back from the exhaust passage 9 into the intake passage 8 during the valve overlap time period, whereby the exhaust flow rate exhibits a negative value, and the negative value becomes lowest in the vicinity of the overlap center position OVL_Center. That is, the amount of burned gases flowing back into the intake passage 8 becomes maximum. Accordingly, the exhaust pressure Pex exhibits the minimum value immediately before the amount of burned gases flowing back becomes maximum, as shown in FIG. 6C.

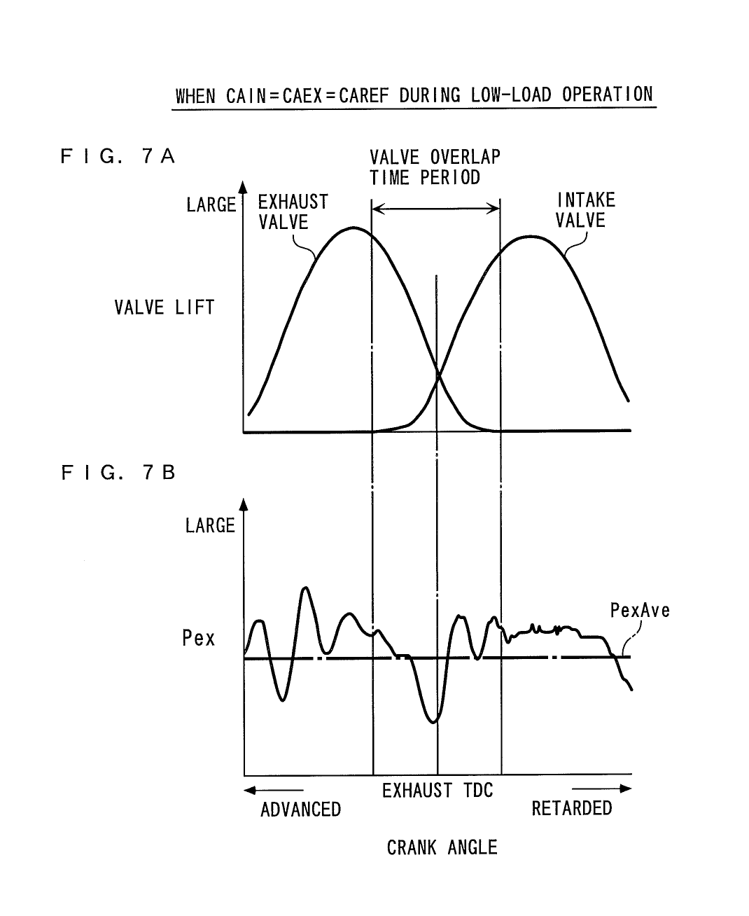

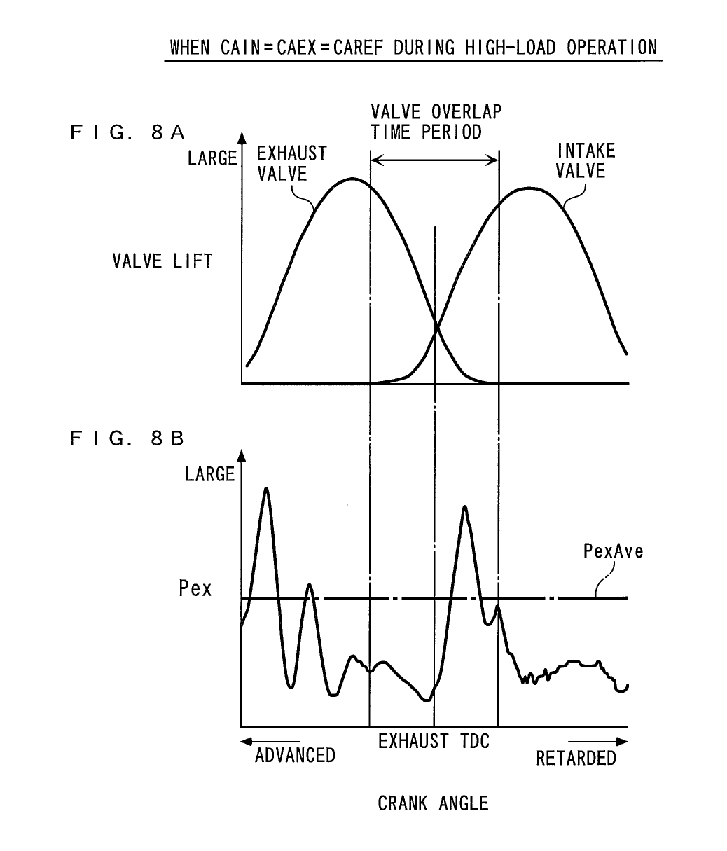

Further, FIGS. 7A and 7B and FIGS. 8A and 8B show the results of measurement of the exhaust pressure Pex during the low-load operation and high-load operation of the engine 3 in a case where both the intake cam phase CAIN and the exhaust cam phase CAEX are set to a predetermined value CAREF (>0). As is clear from a comparison between FIGS. 7B and 8B, it is understood that the amount of fluctuation in the exhaust pressure Pex during the valve overlap time period becomes larger during the high-load operation of the engine 3 than during the low-load operation thereof, and a degree by which the exhaust pressure Pex is lower than the average exhaust pressure PexAve (i.e. the degree of deviation of Pex from PexAve) becomes larger.

Therefore, when the basic blown back gas amount GegrRV_Base is calculated using the average exhaust pressure PexAve, an error between the basic blown back gas amount GegrRV_Base and an actual blown back gas amount is small during the low-load operation, whereas during the high-load operation, the error therebetween becomes larger.

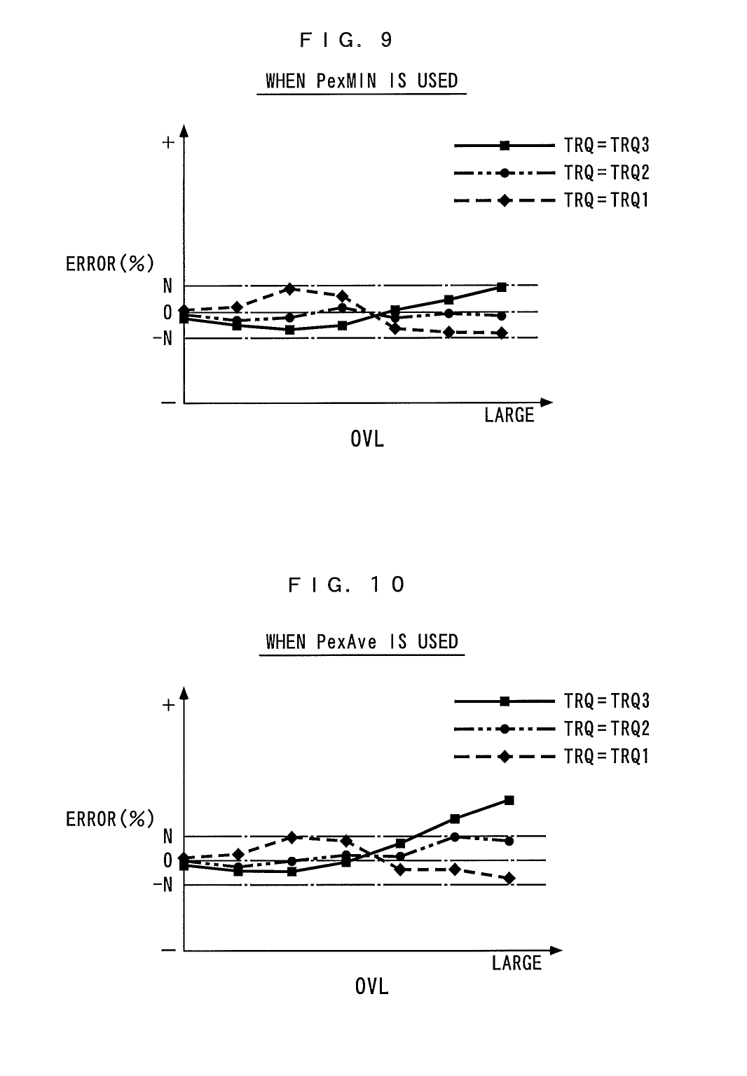

Here, it is estimated that in view of the data of the exhaust pressure Pex shown in FIGS. 7B and 8B, the minimum exhaust pressure PexMIN more appropriately represents the tendency of fluctuation in the exhaust pressure Pex during the valve overlap time period, particularly the tendency of fluctuation in the exhaust pressure Pex during the high-load operation of the engine 3 during the valve overlap time period, than the average exhaust pressure PexAve. The basic blown back gas amount GegrRV_Base is calculated based on each of the above estimation using the minimum exhaust pressure PexMIN and the average exhaust pressure PexAve, and an error (%) of each result of calculation of the basic blown back gas amount with respect to the actual blown back gas amount is calculated. Results of these calculations are shown in FIGS. 9 and 10.

In FIGS. 9 and 10, TRQ1 to TRQ3 represent predetermined values of the demanded torque TRQ, which satisfy the relationship of TRQ1<TRQ2<TRQ3. As shown in FIG. 9, it is understood that when the basic blown back gas amount GegrRV_Base is calculated using the minimum exhaust pressure PexMIN, the error is within a range of ±N % (N is an integer) irrespective of the magnitude of the overlap angle OVL. On the other hand, as shown in FIG. 10, it is understood that when the basic blown back gas amount GegrRV_Base is calculated using the average exhaust pressure PexAve, in a state where the overlap angle OVL is large and the demanded torque TRQ is large, that is, in a state where the valve overlap time period is long and operating load is high, the error exceeds the value N, which means that the calculation accuracy is reduced.

More specifically, when the basic blown back gas amount GegrRV_Base is calculated, in the state where the valve overlap time period is long or during the high-load operation of the engine 3, in other words, when the degree of fluctuation in the exhaust pressure Pex during the valve overlap time period is large, the calculation accuracy of the basic blown back gas amount GegrRV_Base is improved by using the minimum exhaust pressure PexMIN instead of using the average exhaust pressure PexAve. Based on the above-described reason and viewpoint, in the present embodiment, the basic blown back gas amount GegrRV_Base is calculated using the minimum exhaust pressure PexMIN.

As described above, according to the internal EGR amount calculation device 1 of the present embodiment, the internal EGR amount Gegr_int is calculated by adding the remaining gas amount Gegrd to the blown back gas amount GegrRV. In this case, the blown back gas amount GegrRV is calculated by calculating the basic blown back gas amount GegrRV_Base using the minimum exhaust pressure PexMIN and adding the correction term dGegr_OVL to the calculated basic blown back gas amount GegrRV_Base. Therefore, for the above-described reason, when the valve overlap time period is long or when the operating load of the engine 3 is high, the calculation accuracy of the blown back gas amount GegrRV can be improved in comparison with the case where the blown back gas amount GegrRV is calculated using the average exhaust pressure PexAve, which makes it possible to improve the calculation accuracy of the internal EGR amount Gegr_int.

Further, since the blown back gas amount GegrRV is calculated using the minimum exhaust pressure PexMIN, there is no possibility that the internal EGR amount Gegr_int is calculated as too large a value, whereby when the engine 3 is controlled using the internal EGR amount Gegr_int thus calculated, it is possible to prevent the combustion state of the engine from being deteriorated to thereby prevent occurrence of knocking.

Furthermore, the amplitude APex is calculated by searching the map according to the demanded torque TRQ and the engine speed NE, and the minimum exhaust pressure PexMIN is calculated by subtracting the amplitude APex from the average exhaust pressure PexAve. Therefore, the blown back gas amount GegrRV can be calculated more easily, and computational load in calculating the blown back gas amount GegrRV can be made smaller, than when the blown back gas amount GegrRV is calculated by the method disclosed in Japanese Laid-Open Patent Publication (Kokai) No. 2004-251182, which executes integral calculation of the effective opening area.

Note that although in the above-described embodiment, the minimum exhaust pressure PexMIN is used as the first exhaust pressure parameter, by way of example, the first exhaust pressure parameter in the present invention is not limited to this, but any suitable first exhaust pressure parameter may be employed insofar as it represents the pressure within the exhaust passage during the valve overlap time period. For example, an average value of the exhaust pressure Pex obtained when the crank angle position is within a range not far from the center position of the valve overlap time period may be employed as the first exhaust pressure parameter.

Further, although in the above-described embodiment, the average exhaust pressure PexAve is used as the second exhaust pressure parameter, by way of example, the second exhaust pressure parameter in the present invention is not limited to this, but any suitable second exhaust pressure parameter may be employed insofar as it represents the pressure within the exhaust passage during a predetermined time period including at least a time period other than the valve overlap time period. For example, an average value of the exhaust pressure Pex in two or more combustion cycles may be employed. Further, an average value of the exhaust pressure Pex sampled within one combustion cycle at a sampling period shorter than a period at which the average exhaust pressure PexAve is calculated may be employed.

Furthermore, although in the above-described embodiment, the minimum exhaust pressure PexMIN is calculated by the method of subtracting the amplitude A Pex calculated by searching a map, from the average exhaust pressure PexAve, by way of example, the method of calculating the minimum exhaust pressure PexMIN in the present invention is not limited to this, but any suitable method may be employed insofar as it can calculate the minimum value of the exhaust pressure Pex during the valve overlap time period. For example, the exhaust pressure Pex may be sampled at a very short sampling period during the valve overlap time period and the minimum value of the sampled data items may be set as the minimum exhaust pressure PexMIN.

On the other hand, although in the above-described embodiment, the engine speed NE and the intake air amount GAIR are used as values for representing the operating conditions of the engine 3, by way of example, the values for representing the operating conditions of the engine 3 are not limited to these, but any suitable values may be employed insofar as they can represent the operating conditions of the engine 3. For example, the degree of opening of an accelerator pedal, the temperature of engine coolant of the engine 3, and so forth may be employed as values for representing the operating conditions of the engine 3.

Further, although in the above-described embodiment, the engine 3 including the variable intake cam phase mechanism 12 and the variable exhaust cam phase mechanism 22 is used as an internal combustion engine in which the valve timing of at least one of the intake valves 4 and the exhaust valves 5 are changed, by way of example, the internal combustion engine to which the present invention is applied is not limited to this, but any suitable engine may be employed insofar as it can change the valve timing of at least one of the intake valves and the exhaust valves. For example, as the engine 3, there may be employed an internal combustion engine including one of the variable intake cam phase mechanism 12 and the variable exhaust cam phase mechanism 22 or an internal combustion engine which changes the valve timing of at least one of the intake valves 4 and the exhaust valves 5 using a mechanism other than the variable intake cam phase mechanism 12 and the variable exhaust cam phase mechanism 22. For example, as a mechanism for changing the cam phase, there may be employed a variable cam phase mechanism formed by combining an electric motor and a gear mechanism, an electromagnetic valve-actuating mechanism which has a valve element actuated by a solenoid, or a valve timing changing mechanism for mechanically changing the valve timing using a three-dimensional cam.

Further, although in the above-described embodiment, the internal EGR amount calculation device 1 according to the present invention is applied to the engine 3 installed on a vehicle, by way of example, this is not limitative, but it can be applied to an internal combustion engine installed on boats or other industrial machines.

It is further understood by those skilled in the art that the foregoing are preferred embodiments of the invention, and that various changes and modifications may be made without departing from the spirit and scope thereof.

What is claimed is:

1. An internal EGR amount calculation device for an internal combustion engine in which a valve overlap time period of an intake valve and an exhaust valve of a cylinder is changed by changing valve timing of at least one of the intake valve and the exhaust valve and an internal EGR amount is changed according to the change in the valve overlap time period, comprising:
first exhaust pressure parameter-obtaining means for obtaining a first exhaust pressure parameter indicative of a pressure within an exhaust passage during the valve overlap time period;
second exhaust pressure parameter-obtaining means for obtaining a second exhaust pressure parameter indicative of the pressure within the exhaust passage during a predetermined time period including at least a time period other than the valve overlap time period;
blown back gas amount-calculating means for calculating a blown back gas amount, which is an amount of burned gases which temporarily flow out of the cylinder into at least one of an intake system and an exhaust system, and then flow back into the cylinder again, according to the first exhaust pressure parameter;
remaining gas amount-calculating means for calculating a remaining gas amount, which is an amount of burned gases remaining in the cylinder, according to the second exhaust pressure parameter; and
internal EGR amount-calculating means for calculating the internal EGR amount based on the remaining gas amount and the blown back gas amount.

2. The internal EGR amount calculation device as claimed in claim 1, wherein said first exhaust pressure parameter-obtaining means obtains a minimum exhaust pressure, which is a minimum value of the pressure within the exhaust passage during the valve overlap time period, as the first exhaust pressure parameter.

3. The internal EGR amount calculation device as claimed in claim 2, wherein said second exhaust pressure parameter-obtaining means includes average exhaust pressure-calculating means for calculating an average exhaust pressure, which is an average value of the pressure within the exhaust passage during the predetermined time period, as the second exhaust pressure parameter, and
wherein said first exhaust pressure parameter-obtaining means includes:
amplitude calculating means for calculating an amplitude for calculating the minimum exhaust pressure, according to a value indicative of an operating condition of the engine; and
minimum exhaust pressure-calculating means for calculating the minimum exhaust pressure, based on the amplitude and the average exhaust pressure.
